(19) United States
(12) Patent Application Publication
(10) Pub. No.: US 2006/0286340 A1
(43) Pub. Date: Dec. 21, 2006

(54) Adhesive closing part

(76) Inventor: Konstantinos Poulakis, Hildrizhausen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/570,520

(22) PCT Filed: Jul. 23, 2004
(86) PCT No.: PCT/EP04/08214

§ 371 Date: Mar. 3, 2006

(30) Foreign Application Priority Data
Sep. 6, 2003 (DE) 103 41 152.6

(51) Int. Cl. B32B 3/06

(52) U.S. Cl. 428/99; 428/100; 24/442

(57) ABSTRACT

The invention relates to an adhesive closing part comprising a support band (10) that is provided with hooking elements (12) which are disposed thereupon, and a cover band (18) that covers the support band (10) on the side facing away from the hooking elements (12) and is wider than the support band (10) such that lateral edge zones (20) of the cover band (18) extend beyond the associated longitudinal edges of the support band (10) on both sides. At least one additional cover band is provided whose free lateral edge zones also extend beyond the associated longitudinal edges of the support band (10) such that another sealing system is created in addition to the first sealing system, resulting in an overall improvement of the sealing effect.

The invention relates to an adhesive closing part having a support strip with interlocking elements mounted on it and having a cover strip on the side facing away from the interlocking elements covering the support strip, the cover strip being wider than the support strip so that free side edge areas of the cover strip extend on both sides beyond the associated longitudinal edges of the support strip.

Adhesive fastener elements such as this are employed for a variety of purposes, such as in automotive technology, flooring technology, clothing of all kinds, and for special applications in mechanical engineering. Adhesive fastener elements have proved themselves to be reliable detachable connection and fastening elements in these fields. When such adhesive fastener elements are used for aircraft or motor vehicle passenger seats, they serve the purpose of fastening seat covers to foamed parts; some adhesive fastener elements are foamed into the foam upholstery material during production of the respective seat, while the adhesive fastener element with the corresponding interlocking elements is fastened to the cover upholstery material, in particular is sewn on. For the purpose of producing the foam body element the adhesive fastener elements are introduced into so-called seating pipes of a foam injection mold and, by introduction of foam material into the free cross-sections of the foam injection mold, preferably one of PU foam, the adhesive fastener elements are fastened on the foam body elements in the foam injection process. The pipes employed normally project above the other walls of the foam injection mold and thus later form groove-like recesses in the foam body element which is then engaged in the upholstery cover material with the other corresponding adhesive fastener element. In this way geometric seam and shape patterns may be reproduced on a particular seat.

DE-A-199 56 011 discloses an adhesive fastener element for application for this purpose in the seating area, one having a support strip and interlocking elements mounted on the support strip; the support strip has at least one reinforcing element resistant to bending, one which extends preferably along the support strip in the form of a bending wire. Application of the solution disclosed results in better embedding properties in foam molds for adhesive fastener elements and, because of the flexural strength of the reinforcing element, once adhesive fastener elements have been introduced into the respective foam injection mold, they remain in their position. In the solution disclosed the cover strip is applied in one layer so as to be flush with the upper side of the foam injection mold, and so the possibility is not to be excluded that, during the foam injection process itself preferably involving polyurethane foam, the latter may raise the cover strip above the side edges of the foam injection mold and so reach the interior of the channel-like injection mold in which the support strip with bending wire and the interlocking elements is seated. However, penetration of the intermediate areas of the interlocking elements by the foam weakens the fastening capability of these elements, so that they may not be effective when engaged with corresponding closing elements of the other component; this on the whole reduces the adherence of the disclosed adhesive fastener elements.

In order to offset this disadvantage DE-A-100 39 940 has already proposed for a generic adhesive fastener element a cover strip which is wider than the support strip. The two free side edge areas of the cover strip are each folded back on themselves in the direction of the support strip along a fold line extending in the longitudinal direction, so that the end edges of the free side edge areas of the cover strip face the longitudinal edges of the support strip. As a result, the cover strip has on both sides a sort of sealing lip which always extends along the area having the interlocking elements and is adjacent to the wall elements of the foam injection mold which encloses the molding depression in which the interlocking elements are received during the foaming process. The foam material introduced into the foam injection mold causes this sealing lip to be pressed against the facing wall elements of the mold. As a result of the certain amount of flexibility in the area of the fold line, the sealing lip rests against the wall areas forming the sealing surface so that the improvement desired in the sealing action as foam barrier is achieved. In order then to impart a certain amount of flexural resistance to the adhesive fastener element, something which perceptibly improves handling during introduction into the foam injection mold, this disclosed solution also has a flexurally resistant element in the form of a bending wire.

Unintentional penetration of foam material in the direction of the interlocking elements may occur even with these disclosed solutions despite this sealing lip configuration. It has been found in particular that the disclosed solution encounters its limits where the foam injection mold for design reasons has a configuration such that the disclosed solution with its side edge areas does not end flush and level with the upper side of a foam injection mold.

On the basis of this state of the art the object of the invention is further to improve the disclosed adhesive fastener elements so that, while their advantages are retained, they have an even better effect in sealing of the molded foam to be introduced into a foam injection mold and so that they may also be adapted to a large number of geometric patterns of a specified foam injection mold. The object as thus described is attained by means of an adhesive fastener element having the characteristics specified in patent claim 1 in its entirety.

In that, as specified in the characterizing part of claim 1, there is present at least one other cover strip the free side areas of which also extend over the associated longitudinal edges of the support strip, in addition to the first sealing system in the form of a projecting cover strip, at least one other comparable sealing system is produced so that, should the first cover system initially facing the foam fail, the second sealing system can produce the effect of sealing off from the molded foam. It has also been found that the geometric surface configuration of the respective cover strip may be configured as desired, so that the solution claimed for the invention allows a greater range of variation in foam injection molds and their cross-sections.

In one preferred embodiment of the adhesive fastener element claimed for the invention provision is made such that the widths of the cover strips stacked one above the other may vary. By preference provision is also made such that, when the adhesive fastener element is in the use position, the respective upper cover strip is one-fourth to one-half, preferably approximately one third, wider than the cover strip immediately below it.

In another especially preferred embodiment of the adhesive fastener element claimed for the invention the cover strip, the support strip, the interlocking elements, and/or the adhesive possess ferromagnetic properties at least to some extent, so that the adhesive fastener element may be held in place on the foam injection mold by means of a magnetic retaining unit such as one in the form of permanent magnet strips in the foam injection mold or in the so-called seating pipe of the foam injection mold, such strips being embedded in the strip-like adhesive fastener element when the latter is aligned.

In order to impart a certain amount of bending resistance to the intrinsically flexible adhesive fastener element with its components, a stiffening section may be embedded in the adhesive layer positioned between cover strip and support strip, something which definitely facilitates handling of the adhesive fastener element when it is introduced into the foam injection mold or the foam injection pipe, especially if specified lengths of the adhesive fastener element are to be introduced into the respective foam injection mold in complex three-dimensional structures. This section may be represented by an iron wire provided with a corrosion-proofing coating, one of zinc in particular. Use of a ferromagnetic stiffening wire may also contribute to magnetic securing of the adhesive fastener element in position on the foam injection mold.

The interlocking elements of the adhesive fastener element claimed for the invention may be in the form of stalk-shaped, hooked, looped, fleece-like, or mushroom-shaped fastener elements.

One embodiment of the adhesive fastener element claimed for the invention will be described in detail below with reference to the drawing, in which, in the form of diagrams not drawn to scale,

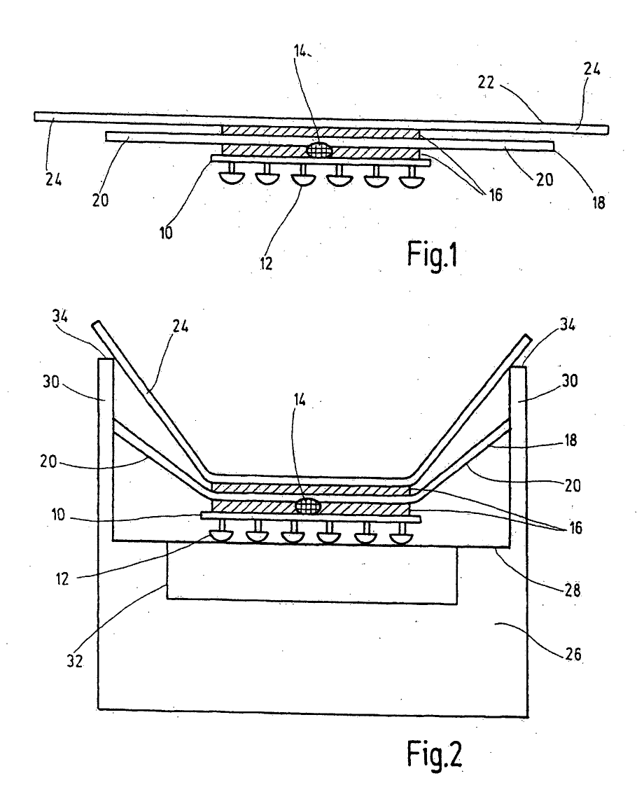

FIG. 1 presents a front view of the adhesive fastener element claimed for the invention;

FIG. 2 a front view of a part of a foam injection mold (foam injection pipe) with adhesive fastener element positioned on it as shown in FIG. 1 in the use position.

The adhesive fastener element claimed for the invention has a support strip 10. Interlocking elements 12 mounted side by side and one behind the other are present on one side of the support strip 10. For example, the adhesive fastener element may be a so-called microfastener in which 200 to 400 interlocking elements per square centimeter are provided on a support strip 10 of a thickness of 0.1 mm to 0.3 mm. An exemplary process for production of the support strip 10 of such a microfastener is disclosed in DE-C-198 28 856. In this disclosed process a thermoplastic material is introduced by means of an extrusion tool into the gap between a pressure tool and a molding tool, a sieve having through openings is used as shaping element, and the interlocking elements being in the form of plastic setting at least to some extent in the holes in the sieve. In addition to the sieve molding process indicated, a different extrusion or casting process may be applied for production of the support strip 10 with interlocking elements 12.

The support strip 10 has a bending-resistant profile-like stiffening element which extends over the entire length of the support strip 10. In the exemplary embodiment illustrated this stiffening section consists of a wire 14, in particular one in the form of a metal wire. This wire 14 is rigidly connected by way of an adhesive means 16 in the form of a layer to the support strip 10 on the rear side of the latter facing away from the interlocking elements 12. The layered adhesive means 16 may consist for example, of a moisture cross-linking polyurethane (PU), but also of an acrylate adhesive or other suitable adhesive means. The adhesive means 16 essentially covers one side of the support strip 10 and is rigidly connected to it. The diameter relationships selected are such that the thickness of the adhesive means applied in the form of the adhesive layer corresponds in approximation to the cross-section of the wire 14. However, as is indicated by the illustrations in the figures, it is also possible for the adhesive means 16, in view of its thickness, to receive the wire 14 with its cross-section as specified only in part and embed it.

The adhesive means 16 indicated is adjoined by a first cover strip 18, which is wider than the support strip 10, so that free side edge areas 20 of the cover strip 18 extend on both sides over the longitudinal edges of the support strip 10. As the figures also show, in the stacked configuration another strip of adhesive means 16 is applied after the first cover strip 18; this strip of adhesive means 16 serves the purpose of immobilizing another second cover strip 22 along its lower side. The two free side edge areas 24 of this second cover strip 22 as well extend beyond the associated longitudinal edges of the support strip 10. The widths of the respective cover strips 18, 22 may be specified as desired; the configuration of these strips is based on the cross-sectional shapes of the respective foam injection pipe as molded foam element. The possibility accordingly exists of designing a cover strip 18 or 22 to be wider or of the same width in an asymmetric configuration as the respective adjacent opposite cover strip 22 or 18. In addition, the configuration claimed for the invention need not be restricted to a two-component configuration of cover strips. The stack number may be increased as a function of the application. In the configuration of the adhesive fastener element shown in its use position, however, the uppermost cover strip 22 is approximately one-third wider than the immediately following subjacent cover strip 18.

The respective cover strip 18, 22 may consist of a textile material, a non-woven material, or a preferably open-pored plastic fabric, in order thus to achieve good adhesion of the foam at least to the upper cover strip 22. Reliable bonding of the adhesive fastener element to the molded foam (not shown) is thereby achieved.

The illustration in FIG. 2 relates to use of an adhesive fastener element as shown in FIG. 1. Part of a foam injection mold as molding tool, in technical language also referred to as foam injection pipe 26, is shown in cross-section in FIG. 2. The foam injection pipe 26 forms in cross-section a channel-like foam injection mold having a bottom element 28 with two side walls 30 projecting vertically in the same direction and to the same height. In addition, there is introduced into the bottom element 28 of the foam injection pipe a bar-shaped magnet element 32, an element which functions as part of a ferromagnetic adherence system in conjunction with the corresponding components of the adhesive fastener element shown in FIG. 1. Provision may also be made such that the respective cover strip 18, 22 and/or the support strip 10 and/or the interlocking elements 12 and/or the adhesive means 16 at least to some extent possess ferromagnetic properties. The iron particles preferably employed may be integrated into the respective element of the adhesive fastener element and/or applied to the respective components as a coating. The possibility also exists of applying a ferromagnetic powder as a coating paste. However, depending on the components of the adhesive fastener element provided with ferromagnetic properties as described, by preference full-area contact with the magnet element 32 of the foam injection mold 26 is obtained.

As FIG. 2 also shows, use of the adhesive fastener element claimed for the invention as described is such that it is introduced into the channel-like foam injection tool 26 with both side edge areas 20 of the first cover strip 18 in interior contact with the side walls 30 of the foam injection tool 26, and that the two side edge areas 24 of the other cover strip 22 extend to some extent beyond the free ends 34 of these side walls 30. If foam material is now introduced into the foam injection mold, it is retained by way of the first sealing area formed between the two side edge areas 24 and free ends 34 of the side walls 30 and any foam material which nevertheless succeeds in penetrating is then forced back by way of the second sealing system consisting of the side edge areas 20 of the cover strip 18 and the interior of the two side walls 30 of the foam injection tool 26. The sealing effect of the second sealing system is increased further in that the foam flowing in presses the cover strip 18 with its two side edge areas 20 against the side walls 30.

It has been found to be especially favorable for the effectiveness of sealing to cause the respective side edge areas 20, 24 to project wing-like above the other support strip 10, in particular to provide angular bending areas, the side edge areas 20 extending at angles within the a range of 20° to 45°, preferably 30°, from the horizontal and the other side edge areas 24 at an angle of 30° to 60°, preferably approximately 45°, from the horizontal.

The adhesive fastener element claimed for the invention is especially well suited for aircraft or motor vehicle passenger seats; it serves the purpose of fastening seat covers on foam body elements, some adhesive fastener elements being injected into the upholstery foam material along with the foam in production of the respective seat and the adhesive fastener elements being fastened by the corresponding interlocking elements to the upholstery cover material.

1. An adhesive closing part having a support strip (10) with interlocking elements (12) mounted on it and having a cover strip (18) on the side facing away from the interlocking elements (12) covering the support strip, the cover strip (18) being wider than the support strip (10), so that free side edge areas (20) of the cover strip (18) extend on both sides beyond the associated longitudinal edges of the support strip (10), characterized in that at least one other cover strip (22) is present the free side areas (24) of which also extend beyond the associated longitudinal edges of the support strip (10).

2. The adhesive fastener element as claimed in claim 1, wherein the respective cover strips (18, 22) differ in width and are positioned one above the other in a stacking sequence.

3. The adhesive fastener element as claimed in claim 2, wherein, when in its use position, the uppermost cover strip (22) in the stacking sequence is approximately one-fourth to one-half, preferably approximately one-third, wider than the immediately following subjacent cover strip (18).

4. The adhesive fastener element as claimed in claim 1, wherein the respective cover strip (18) is joined by an adhesive means (16) to the adjacent cover strip (22) or to the support strip (10).

5. The adhesive fastener element as claimed in claim 1, wherein the respective cover strip (18, 22) consists of a textile material, a non-woven material, or a plastic fabric and wherein the interlocking elements (12) consist of polyamide or polypropylene.

6. The adhesive fastener element as claimed in claim 1, wherein the support strip (10) with interlocking elements (12) is obtained by an extrusion process or molding process.

7. The adhesive fastener element as claimed in claim 1, wherein the respective cover strip (18, 22), the support strip (10), the interlocking elements (12), and/or the adhesive means (16) at least to some extent possess ferromagnetic properties.

8. The adhesive fastener element as claimed in claim 1, wherein such element has a stiffening element which preferably is in the form of a bending wire (14), extends along the support strip (10), and is a component of a ferromagnetic connecting system.

9. Application of an adhesive fastener element as claimed in claim 1, characterized in that such adhesive fastener element is introduced into a channel-like foam injection tool (26) in contact at least with the two side edge areas (30) of the foam injection tool (26), and in that at least one addition cover strip (24) with its two side edge areas (24) extends at least to some extent over the free ends (34) of these side walls (30).
